(19) United States
(12) Patent Application Publication
(10) Pub. No.: US 2024/0176869 A1
(43) Pub. Date: May 30, 2024

(54) DEPENDENCY EMULATION FOR EXECUTABLE SAMPLES

(71) Applicant: Palo Alto Networks, Inc., Santa Clara, CA (US)

(72) Inventors: Esmid Idrizovic, Trumau (AT); Robert Jung, Albuquerque, NM (US); Daniel Raygoza, Seattle, WA (US); Michael S. Hughes, Davenport, FL (US)

(21) Appl. No.: 18/072,452

(22) Filed: Nov. 30, 2022

(51) Int. Cl. G06F 21/53; G06F 21/56

(52) U.S. Cl. CPC G06F 21/53; G06F 21/566; G06F 2221/033

(57) ABSTRACT

Techniques for dependency emulation for executable samples are disclosed. In some embodiments, a system/process/computer program product for dependency emulation for executable samples includes receiving a sample for emulation for malware detection; determining that one or more libraries are missing from the sample for execution of the sample in an emulation environment; generating one or more stub libraries to facilitate the execution of the sample in the emulation environment; and executing the sample in the emulation environment.

### BACKGROUND OF THE INVENTION

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

### BRIEF DESCRIPTION OF THE DRAWINGS

Various embodiments of the invention are disclosed in the following detailed description and the accompanying drawings.

FIG. 1 illustrates an example of an environment in which malicious applications are detected and prevented from causing harm.

FIG. 2A illustrates an embodiment of a data appliance.

FIG. 2B is a functional diagram of logical components of an embodiment of a data appliance.

FIG. 3 illustrates an example of logical components that can be included in a system for analyzing samples.

FIG. 4 illustrates an example of a Windows PE executable and its dependencies.

FIG. 5 illustrates an example of a Windows PE executable and dependencies with two parallel arrays of pointers.

FIG. 6 illustrates an example of when an external dependency is missing for execution of a Windows PE sample in the emulation environment.

FIG. 7 illustrates dynamically generated dependency for performing dynamic analysis of samples with missing external dependencies in accordance with some embodiments.

FIG. 8 is a flow diagram of a process for dependency emulation for executable samples in accordance with some embodiments.

FIG. 9 is another flow diagram of a process for dependency emulation for executable samples in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as one or more software applications on various types of devices, such as computer servers, gateways, network/routing devices (e.g., network routers), and data appliances (e.g., security appliances or other types of special purpose devices), and in various implementations, certain operations can be implemented in special purpose hardware, such as an ASIC or FPGA.

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets-using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls).

For example, Palo Alto Networks' next generation firewalls enable enterprises and service providers to identify and control applications, users, and content—not just ports, IP addresses, and packets-using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

### Overview of Techniques for Dependency Emulation for Executable Samples

Technical and security challenges with performing malware analysis on executable samples (e.g., sample files for malware analysis, such as Microsoft Windows PE files) exist. For example, samples often have dependencies on external libraries (e.g., common external libraries) that are not found in the base Operating System (OS) (e.g., the base OS of the sandbox environment, which is also referred to as an emulation environment, such as for Microsoft Windows 10 or another version/OS platform).

Specifically, dynamic analysis (DA) for malware detection cannot be performed on executable samples with missing dependencies (e.g., required libraries are not found). The inability to properly perform such dynamic analysis on executable samples with such missing dependencies prevents malware detection using dynamic analysis (e.g., the process cannot be created and executed in the sandbox environment, which is also a waste of computing time and resources). Although static analysis on the sample may be performed, some malware can be more accurately and/or effectively detected using dynamic analysis (e.g., polymorphism creates resistance to static signatures). Moreover, these missing dependencies are prevalent among various types of malware (e.g., file infectors, as such files will often have dependencies on external libraries).

As a result, samples with dependencies often cannot be properly executed in the sandbox environments. As such, the malware analysis in the sandbox environment cannot detect and observe any potential malicious behaviors that would be triggered and detected during the emulation in the sandbox environment.

As such, what are needed are new and improved security techniques for performing malware analysis on executable samples that may have such dependencies on external libraries.

Accordingly, techniques for dependency emulation for executable samples are disclosed. Specifically, the disclosed techniques can automatically determine that there is an external executable library that is missing from the sandbox environment as will be further described below.

In some embodiments, a system/process/computer program product for dependency emulation for executable samples includes receiving a sample for emulation for malware detection; determining that one or more libraries are missing from the sample for execution of the sample in an emulation environment; generating one or more stub libraries to facilitate the execution of the sample in the emulation environment; and executing the sample in the emulation environment.

In some embodiments, a system/process/computer program product for dependency emulation for executable samples includes receiving a sample for emulation for malware detection; determining that one or more libraries are missing from the sample for execution of the sample in an emulation environment; intercepting a loader response for a dynamic linked library (DLL) search to spoof an import response to facilitate the execution of the sample in the emulation environment; and executing the sample in the emulation environment.

For example, the emulation environment can be configured to request that the OS of the emulation environment load the sample executable with a stub library in place of the expected library, which can facilitate observation of at least some of the execution of that sample (e.g., in many cases, this facilitates a successful execution of the initialization phase of malware, which generally includes unpacking the second stage of the payloads in memory, which can then be used for malware detection in the emulation environment for most executable samples with such missing dependencies). In an example implementation, the emulation environment can be configured to instrument any potential calls to the external library in order to track if and when it is called and will terminate the execution of the sample in the emulation environment (e.g., as the solution generally utilizes the execution and memory analysis events up to this point in execution for successful detection of malware).

As such, the disclosed techniques for dependency emulation for executable samples can be performed to execute such samples that require external libraries that are not found in the base operating system of the emulation/sandbox environment and use dynamic analysis to detect malware associated with the sample as will now be further described below with respect to various embodiments.

### Example System Environments for Dependency Emulation for Executable Samples

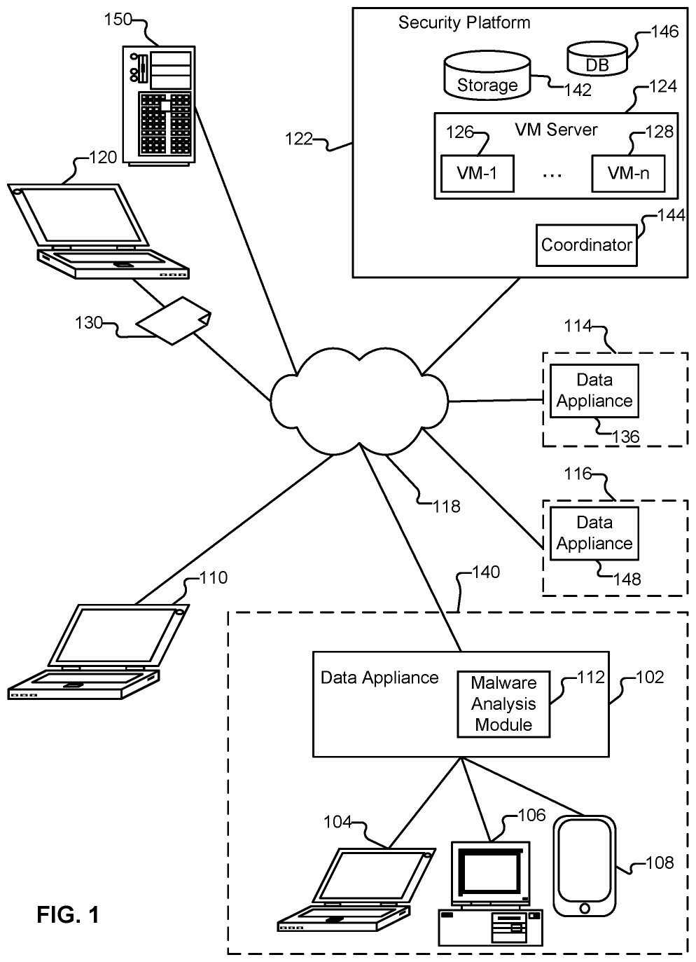

FIG. 1 illustrates an example of an environment in which malicious applications (“malware”) are detected and prevented from causing harm. As will be described in more detail below, malware classifications (e.g., as made by security platform 122) can be variously shared and/or refined among various entities included in the environment shown in FIG. 1. And, using techniques described herein, devices, such as endpoint client devices 104-110 can be protected from such malware.

The term “application” is used throughout the Specification to collectively refer to programs, bundles of programs, manifests, packages, etc., irrespective of form/platform. An “application” (also referred to herein as a “sample”) can be a standalone file (e.g., a calculator application having the filename “calculator.apk” or “calculator.exe”) and can also be an independent component of another application (e.g., a mobile advertisement SDK or library embedded within the calculator app).

“Malware” as used herein refers to an application that engages in behaviors, whether clandestinely or not (and whether illegal or not), of which a user does not approve/would not approve if fully informed. Examples of malware include Trojans, viruses, rootkits, spyware, hacking tools, keyloggers, etc. One example of malware is a desktop application that collects and reports to a remote server the end user's location (but does not provide the user with location-based services, such as a mapping service). Another example of malware is a malicious Android Application Package .apk (APK) file that appears to an end user to be a free game, but stealthily sends SMS premium messages (e.g., costing $10 each), running up the end user's phone bill. Another example of malware is an Apple iOS flashlight application that stealthily collects the user's contacts and sends those contacts to a spammer. Other forms of malware can also be detected/thwarted using the techniques described herein (e.g., ransomware). Further, while n-grams/feature vectors/output accumulation variables are described herein as being generated for malicious applications, techniques described herein can also be used in various embodiments to generate profiles for other kinds of applications (e.g., adware profiles, goodware profiles, etc.).

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, etc.). In the example environment shown in FIG. 1, client devices 104-108 are a laptop computer, a desktop computer, and a tablet (respectively) present in an enterprise network 140. Client device 110 is a laptop computer present outside of enterprise network 140.

Data appliance 102 is configured to enforce policies regarding communications between client devices, such as client devices 104 and 106, and nodes outside of enterprise network 140 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, files exchanged through instant messaging programs, and/or other file transfers. In some embodiments, data appliance 102 is also configured to enforce policies with respect to traffic that stays within enterprise network 140.

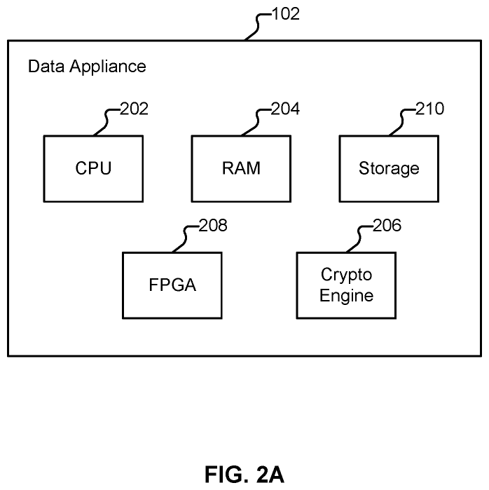

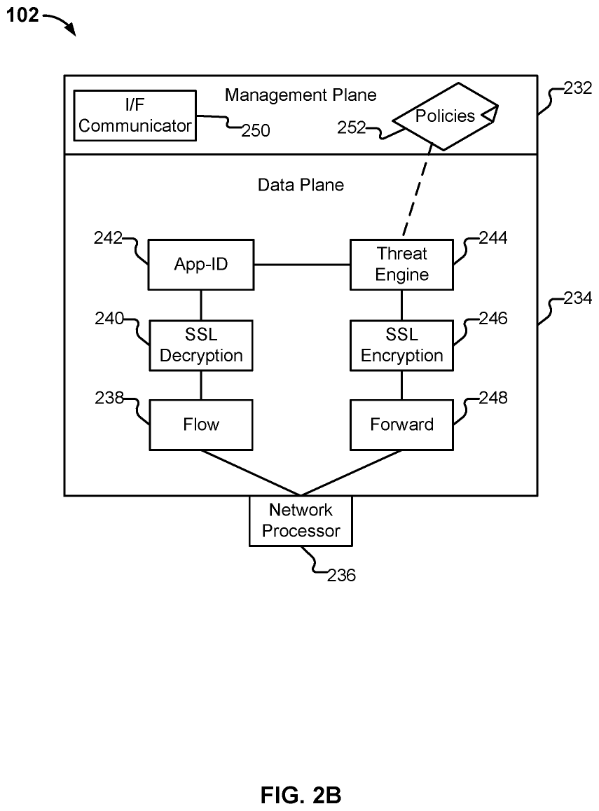

An embodiment of a data appliance is shown in FIG. 2A. The example shown is a representation of physical components that are included in data appliance 102, in various embodiments. Specifically, data appliance 102 includes a high performance multi-core Central Processing Unit (CPU) 202 and Random Access Memory (RAM) 204. Data appliance 102 also includes a storage 210 (such as one or more hard disks or solid state storage units). In various embodiments, data appliance 102 stores (whether in RAM 204, storage 210, and/or other appropriate locations) information used in monitoring enterprise network 140 and implementing disclosed techniques. Examples of such information include application identifiers, content identifiers, user identifiers, requested URLs, IP address mappings, policy and other configuration information, signatures, hostname/URL categorization information, malware profiles, and machine learning models. Data appliance 102 can also include one or more optional hardware accelerators. For example, data appliance 102 can include a cryptographic engine 206 configured to perform encryption and decryption operations, and one or more Field Programmable Gate Arrays (FPGAs) 208 configured to perform matching, act as network processors, and/or perform other tasks.

Functionality described herein as being performed by data appliance 102 can be provided/implemented in a variety of ways. For example, data appliance 102 can be a dedicated device or set of devices. The functionality provided by data appliance 102 can also be integrated into or executed as software on a general purpose computer, a computer server, a gateway, and/or a network/routing device. In some embodiments, at least some services described as being provided by data appliance 102 are instead (or in addition) provided to a client device (e.g., client device 104 or client device 110) by software executing on the client device.

Whenever data appliance 102 is described as performing a task, a single component, a subset of components, or all components of data appliance 102 may cooperate to perform the task. Similarly, whenever a component of data appliance 102 is described as performing a task, a subcomponent may perform the task and/or the component may perform the task in conjunction with other components. In various embodiments, portions of data appliance 102 are provided by one or more third parties. Depending on factors such as the amount of computing resources available to data appliance 102, various logical components and/or features of data appliance 102 may be omitted and the techniques described herein adapted accordingly. Similarly, additional logical components/features can be included in embodiments of data appliance 102 as applicable. One example of a component included in data appliance 102 in various embodiments is an application identification engine which is configured to identify an application (e.g., using various application signatures for identifying applications based on packet flow analysis). For example, the application identification engine can determine what type of traffic a session involves, such as Web Browsing—Social Networking; Web Browsing—News; SSH; and so on.

FIG. 2B is a functional diagram of logical components of an embodiment of a data appliance. The example shown is a representation of logical components that can be included in data appliance 102 in various embodiments. Unless otherwise specified, various logical components of data appliance 102 are generally implementable in a variety of ways, including as a set of one or more scripts (e.g., written in Java, python, etc., as applicable).

As shown, data appliance 102 comprises a firewall, and includes a management plane 232 and a data plane 234. The management plane is responsible for managing user interactions, such as by providing a user interface for configuring policies and viewing log data. The data plane is responsible for managing data, such as by performing packet processing and session handling.

Network processor 236 is configured to receive packets from client devices, such as client device 108, and provide them to data plane 234 for processing. Whenever flow module 238 identifies packets as being part of a new session, it creates a new session flow. Subsequent packets will be identified as belonging to the session based on a flow lookup. If applicable, SSL decryption is applied by SSL decryption engine 240. Otherwise, processing by SSL decryption engine 240 is omitted. Decryption engine 240 can help data appliance 102 inspect and control SSL/TLS and SSH encrypted traffic, and thus help to stop threats that might otherwise remain hidden in encrypted traffic. Decryption engine 240 can also help prevent sensitive content from leaving enterprise network 140. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 242 is configured to determine what type of traffic a session involves. As one example, application identification engine 242 can recognize a GET request in received data and conclude that the session requires an HTTP decoder. In some cases, e.g., a web browsing session, the identified application can change, and such changes will be noted by data appliance 102. For example, a user may initially browse to a corporate Wiki (classified based on the URL visited as “Web Browsing—Productivity”) and then subsequently browse to a social networking site (classified based on the URL visited as “Web Browsing—Social Networking”). Different types of protocols have corresponding decoders.

Based on the determination made by application identification engine 242, the packets are sent, by threat engine 244, to an appropriate decoder configured to assemble packets (which may be received out of order) into the correct order, perform tokenization, and extract out information. Threat engine 244 also performs signature matching to determine what should happen to the packet. As needed, SSL encryption engine 246 can re-encrypt decrypted data. Packets are forwarded using a forward module 248 for transmission (e.g., to a destination).

As also shown in FIG. 2B, policies 252 are received and stored in management plane 232. Policies can include one or more rules, which can be specified using domain and/or host/server names, and rules can apply one or more signatures or other matching criteria or heuristics, such as for security policy enforcement for subscriber/IP flows based on various extracted parameters/information from monitored session traffic flows. An interface (I/F) communicator 250 is provided for management communications (e.g., via (REST) APIs, messages, or network protocol communications or other communication mechanisms).

### Security Platform

Returning to FIG. 1, suppose a malicious individual (using system 120) has created malware 130. The malicious individual hopes that a client device, such as client device 104, will execute a copy of malware 130, compromising the client device, and, e.g., causing the client device to become a bot in a botnet. The compromised client device can then be instructed to perform tasks (e.g., cryptocurrency mining, or participating in denial of service attacks) and to report information to an external entity, such as command and control (C&C) server 150, as well as to receive instructions from C&C server 150, as applicable.

Suppose data appliance 102 has intercepted an email sent (e.g., by system 120) to a user, “Alice,” who operates client device 104. A copy of malware 130 has been attached by system 120 to the message. As an alternate, but similar scenario, data appliance 102 could intercept an attempted download by client device 104 of malware 130 (e.g., from a website). In either scenario, data appliance 102 determines whether a signature for the file (e.g., the email attachment or website download of malware 130) is present on data appliance 102. A signature, if present, can indicate that a file is known to be safe (e.g., is whitelisted), and can also indicate that the file is known to be malicious (e.g., is blacklisted).

In various embodiments, data appliance 102 is configured to work in cooperation with security platform 122. As one example, security platform 122 can provide to data appliance 102 a set of signatures of known-malicious files (e.g., as part of a subscription). If a signature for malware 130 is included in the set (e.g., an MD5 hash of malware 130), data appliance 102 can prevent the transmission of malware 130 to client device 104 accordingly (e.g., by detecting that an MD5 hash of the email attachment sent to client device 104 matches the MD5 hash of malware 130). Security platform 122 can also provide to data appliance 102 a list of known malicious domains and/or IP addresses, allowing data appliance 102 to block traffic between enterprise network 140 and C&C server 150 (e.g., where C&C server 150 is known to be malicious). The list of malicious domains (and/or IP addresses) can also help data appliance 102 determine when one of its nodes has been compromised. For example, if client device 104 attempts to contact C&C server 150, such attempt is a strong indicator that client 104 has been compromised by malware (and remedial actions should be taken accordingly, such as quarantining client device 104 from communicating with other nodes within enterprise network 140). As will be described in more detail below, security platform 122 can also provide other types of information to data appliance 102 (e.g., as part of a subscription) such as a set of machine learning models usable by data appliance 102 to perform inline analysis of files.

A variety of actions can be taken by data appliance 102 if no signature for an attachment is found, in various embodiments. As a first example, data appliance 102 can fail-safe, by blocking transmission of any attachments not whitelisted as benign (e.g., not matching signatures of known good files). A drawback of this approach is that there may be many legitimate attachments unnecessarily blocked as potential malware when they are in fact benign. As a second example, data appliance 102 can fail-danger, by allowing transmission of any attachments not blacklisted as malicious (e.g., not matching signatures of known bad files). A drawback of this approach is that newly created malware (previously unseen by platform 122) will not be prevented from causing harm.

As a third example, data appliance 102 can be configured to provide the file (e.g., malware 130) to security platform 122 for static/dynamic analysis, to determine whether it is malicious and/or to otherwise classify it. A variety of actions can be taken by data appliance 102 while analysis by security platform 122 of the attachment (for which a signature is not already present) is performed. As a first example, data appliance 102 can prevent the email (and attachment) from being delivered to Alice until a response is received from security platform 122. Assuming platform 122 takes approximately 15 minutes to thoroughly analyze a sample, this means that the incoming message to Alice will be delayed by 15 minutes. Since, in this example, the attachment is malicious, such a delay will not impact Alice negatively. In an alternate example, suppose someone has sent Alice a time sensitive message with a benign attachment for which a signature is also not present. Delaying delivery of the message to Alice by 15 minutes will likely be viewed (e.g., by Alice) as unacceptable. As will be described in more detail below, an alternate approach is to perform at least some real-time analysis on the attachment on data appliance 102 (e.g., while awaiting a verdict from platform 122). If data appliance 102 can independently determine whether the attachment is malicious or benign, it can take an initial action (e.g., block or allow delivery to Alice), and can adjust/take additional actions once a verdict is received from security platform 122, as applicable.

Security platform 122 stores copies of received samples in storage 142 and analysis is commenced (or scheduled, as applicable). One example of storage 142 is an Apache Hadoop Cluster (HDFS). Results of analysis (and additional information pertaining to the applications) are stored in database 146. In the event an application is determined to be malicious, data appliances can be configured to automatically block the file download based on the analysis result. Further, a signature can be generated for the malware and distributed (e.g., to data appliances such as data appliances 102, 136, and 148) to automatically block future file transfer requests to download the file determined to be malicious.

In various embodiments, security platform 122 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 122 can be implemented across a scalable infrastructure comprising multiple such servers, solid state drives, and/or other applicable high-performance hardware. Security platform 122 can comprise several distributed components, including components provided by one or more third parties. For example, portions or all of security platform 122 can be implemented using the Amazon Elastic Compute Cloud (EC2) and/or Amazon Simple Storage Service (S3). Further, as with data appliance 102, whenever security platform 122 is referred to as performing a task, such as storing data or processing data, it is to be understood that a sub-component or multiple sub-components of security platform 122 (whether individually or in cooperation with third party components) may cooperate to perform that task. As one example, security platform 122 can optionally perform static/dynamic analysis in cooperation with one or more virtual machine (VM) servers, such as VM server 124.

An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 122, but may also be provided by a third party. As one example, the virtual machine server can rely on EC2, with the remainder portions of security platform 122 provided by dedicated hardware owned by and under the control of the operator of security platform 122. VM server 124 is configured to provide one or more virtual machines 126-128 for emulating client devices. The virtual machines can execute a variety of operating systems and/or versions thereof. Observed behaviors resulting from executing applications in the virtual machines are logged and analyzed (e.g., for indications that the application is malicious). In some embodiments, log analysis is performed by the VM server (e.g., VM server 124). In other embodiments, analysis is performed at least in part by other components of security platform 122, such as a coordinator 144.

In various embodiments, security platform 122 makes available results of its analysis of samples via a list of signatures (and/or other identifiers) to data appliance 102 as part of a subscription. For example, security platform 122 can periodically send a content package that identifies malware apps (e.g., daily, hourly, or some other interval, and/or based on an event configured by one or more policies). An example content package includes a listing of identified malware apps, with information such as a package name, a hash value for uniquely identifying the app, and a malware name (and/or malware family name) for each identified malware app. The subscription can cover the analysis of just those files intercepted by data appliance 102 and sent to security platform 122 by data appliance 102, and can also cover signatures of all malware known to security platform 122 (or subsets thereof, such as just mobile malware but not other forms of malware (e.g., PDF malware)). As will be described in more detail below, platform 122 can also make available other types of information, such as machine learning models that can help data appliance 102 detect malware (e.g., through techniques other than hash-based signature matching).

In various embodiments, security platform 122 is configured to provide security services to a variety of entities in addition to (or, as applicable, instead of) an operator of data appliance 102. For example, other enterprises, having their own respective enterprise networks 114 and 116, and their own respective data appliances 136 and 148, can contract with the operator of security platform 122. Other types of entities can also make use of the services of security platform 122. For example, an Internet Service Provider (ISP) providing Internet service to client device 110 can contract with security platform 122 to analyze applications which client device 110 attempts to download. As another example, the owner of client device 110 can install software on client device 110 that communicates with security platform 122 (e.g., to receive content packages from security platform 122, use the received content packages to check attachments in accordance with techniques described herein, and transmit applications to security platform 122 for analysis).

### Analyzing Samples Using Static/Dynamic Analysis

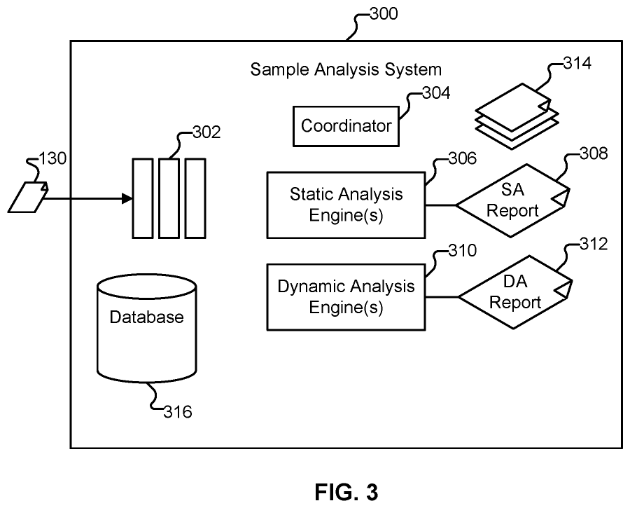

FIG. 3 illustrates an example of logical components that can be included in a system for analyzing samples. Analysis system 300 can be implemented using a single device. For example, the functionality of analysis system 300 can be implemented in a malware analysis module 112 incorporated into data appliance 102. Analysis system 300 can also be implemented, collectively, across multiple distinct devices. For example, the functionality of analysis system 300 can be provided by security platform 122.

In various embodiments, analysis system 300 makes use of lists, databases, or other collections of known safe content and/or known bad content (collectively shown in FIG. 3 as collection 314). Collection 314 can be obtained in a variety of ways, including via a subscription service (e.g., provided by a third party) and/or as a result of other processing (e.g., performed by data appliance 102 and/or security platform 122). Examples of information included in collection 314 are: URLs, domain names, and/or IP addresses of known malicious servers; URLs, domain names, and/or IP addresses of known safe servers; URLs, domain names, and/or IP addresses of known command and control (C&C) domains; signatures, hashes, and/or other identifiers of known malicious applications; signatures, hashes, and/or other identifiers of known safe applications; signatures, hashes, and/or other identifiers of known malicious files (e.g., Android exploit files); signatures, hashes, and/or other identifiers of known safe libraries; and signatures, hashes, and/or other identifiers of known malicious libraries.

### Ingestion

In various embodiments, when a new sample is received for analysis (e.g., an existing signature associated with the sample is not present in analysis system 300), it is added to queue 302. As shown in FIG. 3, application 130 is received by system 300 and added to queue 302.

### Static Analysis

Coordinator 304 monitors queue 302, and as resources (e.g., a static analysis worker) become available, coordinator 304 fetches a sample from queue 302 for processing (e.g., fetches a copy of malware 130). In particular, coordinator 304 first provides the sample to static analysis engine 306 for static analysis. In some embodiments, one or more static analysis engines are included within analysis system 300, where analysis system 300 is a single device. In other embodiments, static analysis is performed by a separate static analysis server that includes a plurality of workers (i.e., a plurality of instances of static analysis engine 306).

The static analysis engine obtains general information about the sample, and includes it (along with heuristic and other information, as applicable) in a static analysis report 308. The report can be created by the static analysis engine, or by coordinator 304 (or by another appropriate component) which can be configured to receive the information from static analysis engine 306. In some embodiments, the collected information is stored in a database record for the sample (e.g., in database 316), instead of or in addition to a separate static analysis report 308 being created (i.e., portions of the database record form the report 308). In some embodiments, the static analysis engine also forms a verdict with respect to the application (e.g., “safe,” “suspicious,” or “malicious”). As one example, the verdict can be “malicious” if even one “malicious” static feature is present in the application (e.g., the application includes a hard link to a known malicious domain). As another example, points can be assigned to each of the features (e.g., based on severity if found; based on how reliable the feature is for predicting malice; etc.) and a verdict can be assigned by static analysis engine 306 (or coordinator 304, if applicable) based on the number of points associated with the static analysis results.

### Dynamic Analysis

Once static analysis is completed, coordinator 304 locates an available dynamic analysis engine 310 to perform dynamic analysis on the application. As with static analysis engine 306, analysis system 300 can include one or more dynamic analysis engines directly. In other embodiments, dynamic analysis is performed by a separate dynamic analysis server that includes a plurality of workers (i.e., a plurality of instances of dynamic analysis engine 310).

Each dynamic analysis worker manages a virtual machine instance. In some embodiments, results of static analysis (e.g., performed by static analysis engine 306), whether in report form (308) and/or as stored in database 316, or otherwise stored, are provided as input to dynamic analysis engine 310. For example, the static report information can be used to help select/customize the virtual machine instance used by dynamic analysis engine 310 (e.g., Microsoft Windows 7 SP 2 vs. Microsoft Windows 10 Enterprise, or iOS 11.0 vs. iOS 12.0). Where multiple virtual machine instances are executed at the same time, a single dynamic analysis engine can manage all of the instances, or multiple dynamic analysis engines can be used (e.g., with each managing its own virtual machine instance), as applicable. As will be explained in more detail below, during the dynamic portion of the analysis, actions taken by the application (including network activity) are analyzed.

In various embodiments, static analysis of a sample is omitted or is performed by a separate entity, as applicable. As one example, traditional static and/or dynamic analysis may be performed on files by a first entity. Once it is determined (e.g., by the first entity) that a given file is malicious, the file can be provided to a second entity (e.g., the operator of security platform 122) specifically for additional analysis with respect to the malware's use of network activity (e.g., by a dynamic analysis engine 310).

The environment used by analysis system 300 is instrumented/hooked such that behaviors observed while the application is executing are logged as they occur (e.g., using a customized kernel that supports hooking and logcat). Network traffic associated with the emulator is also captured (e.g., using pcap). The log/network data can be stored as a temporary file on analysis system 300, and can also be stored more permanently (e.g., using HDFS or another appropriate storage technology or combinations of technology, such as MongoDB). The dynamic analysis engine (or another appropriate component) can compare the connections made by the sample to lists of domains, IP addresses, etc. (314) and determine whether the sample has communicated (or attempted to communicate) with malicious entities.

As with the static analysis engine, the dynamic analysis engine stores the results of its analysis in database 316 in the record associated with the application being tested (and/or includes the results in report 312 as applicable). In some embodiments, the dynamic analysis engine also forms a verdict with respect to the application (e.g., “safe,” “suspicious,” or “malicious”). As one example, the verdict can be “malicious” if even one “malicious” action is taken by the application (e.g., an attempt to contact a known malicious domain is made, or an attempt to exfiltrate sensitive information is observed). As another example, points can be assigned to actions taken (e.g., based on severity if found; based on how reliable the action is for predicting malice; etc.) and a verdict can be assigned by dynamic analysis engine 310 (or coordinator 304, if applicable) based on the number of points associated with the dynamic analysis results. In some embodiments, a final verdict associated with the sample is made based on a combination of report 308 and report 312 (e.g., by coordinator 304).

Dynamic Analysis of Malware with Dependencies

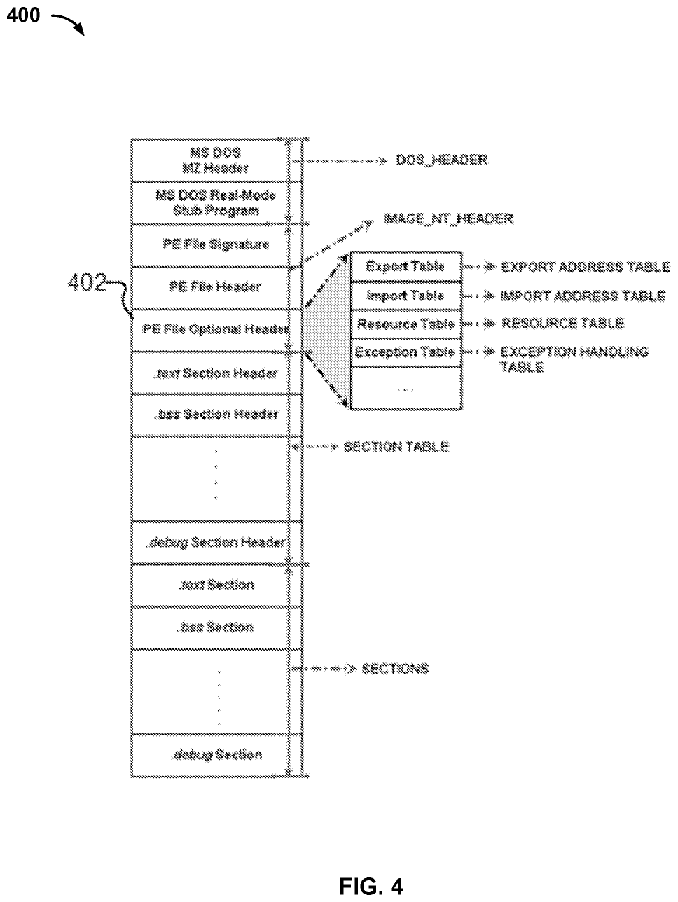

FIG. 4 illustrates an example of a Windows PE executable and its dependencies. Specifically, FIG. 4 illustrates the headers of a Microsoft Windows PE file as shown at 400 that define dependencies or “imports” (e.g., external library dependencies). Referring to FIG. 4, the headers of the Microsoft Windows PE file include a PE File Optional Header as shown at 402. The PE File Optional Header can include an Export Table, an Import Table, a Resource Table, and an Exception Table as shown in FIG. 4.

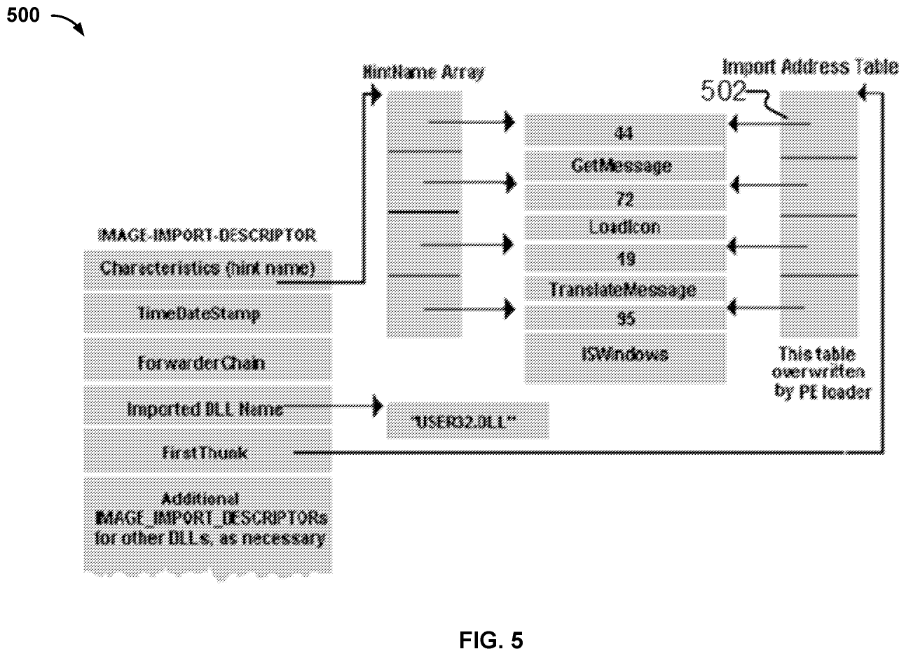

FIG. 5 illustrates an example of a Windows PE executable and dependencies with two parallel arrays of pointers. Referring to FIG. 5, these tables as shown at 500 generally define the set of libraries or “.dll's” (e.g., dynamic link libraries), and the list of functions required within each library. At executable load time, but before execution, the Microsoft Windows PE loader will generally ensure that all libraries are loaded. All import addresses are written into the Import Address Table (IAT) as shown at 502 to make them available for the code in the executable to call.

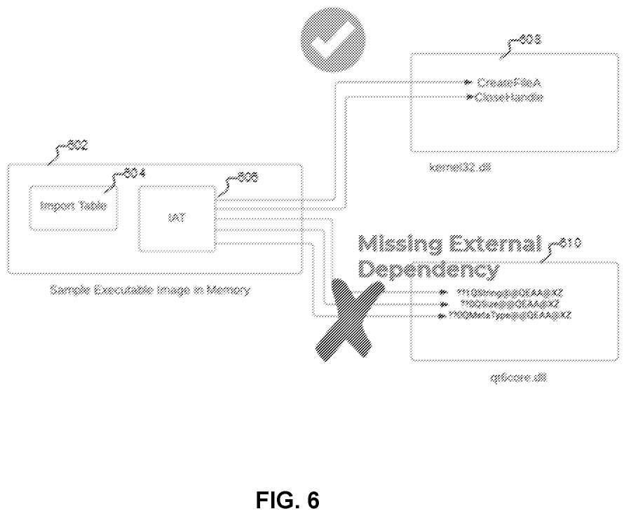

FIG. 6 illustrates an example of when an external dependency is missing for execution of a Windows PE sample in the emulation environment. Referring to FIG. 6, a sample executable image in memory is shown at 602 that includes an importable table 604. When libraries are in the search path, the Windows PE loader will load the dependency and stamp the correct function address into IAT 606. For libraries (e.g., DLLs) that can be found, they can be handled properly as shown at 608.

However, when libraries cannot be found, the Windows PE loader will terminate the process with an error code and the sample under analysis will not execute as shown at 610. As such, the disclosed techniques for dependency emulation for executable samples need to be performed to be able to perform dynamic analysis of such malware samples with missing external dependencies as will now be further described below.

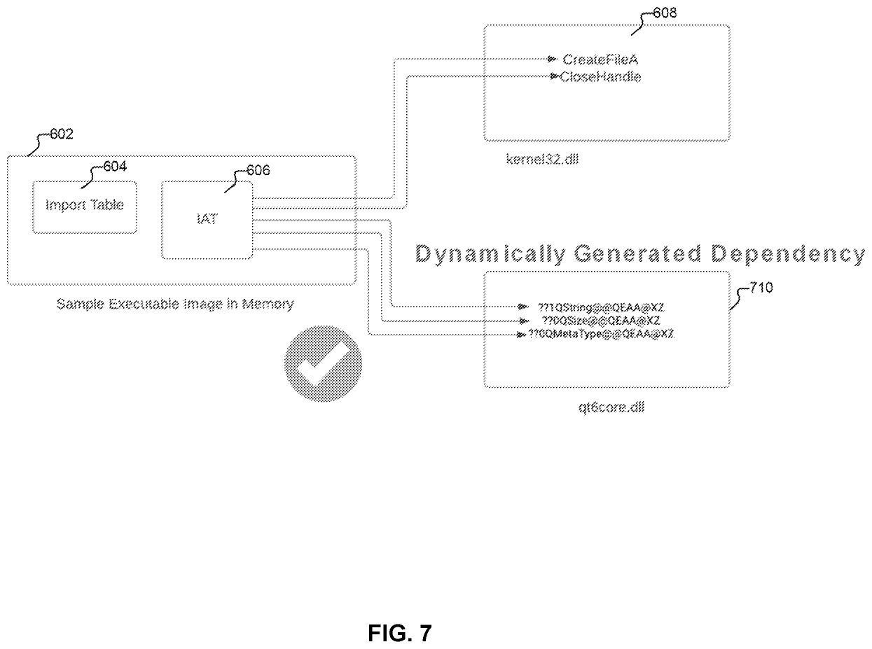

FIG. 7 illustrates dynamically generated dependency for performing dynamic analysis of samples with missing external dependencies in accordance with some embodiments. Referring to FIG. 7, with dependency emulation, for each missing library, a dynamically generated version of the dynamic link library (DLL) is instead loaded as shown at 710. Specifically, each DLL has a function stub for each correct name/ordinals required by the executable image. After the executable is loaded and during execution, if any functions in the dynamically generated library are called, the execution of the process is terminated. This prevents any erroneous results or side effects in execution reports for the dynamic analysis of the sample with such missing external dependencies.

In this example implementation, the emulation environment is configured to force the OS of the emulation environment (e.g., Microsoft Windows) to load the sample executable with a stub library in place of the expected library so that at least some of the execution can be observed (e.g., prior to expiration of a predetermined period of time, such as five minutes or another predetermined period of time for performing dynamic analysis using the instrumented emulation environment, or prior to early termination, such as if any of the functions in the dynamically generated library are called as similarly described above). In most cases this allows successful execution of the initialization phase of the sample (e.g., potential malware), which includes unpacking second stage payloads in memory, which facilitates accurate detection of malware behavior during the dynamic analysis. The emulation environment can instrument any potential calls to the external library in order to track if and when it is called in order to perform such early termination if any of the functions in the dynamically generated library are called as similarly described above. As such, the disclosed system for dependency emulation for executable samples relies on the execution and memory analysis events up to this point in execution for successful detection of malware during the dynamic analysis using the instrumented emulation environment. Accordingly, the disclosed techniques facilitate the execution of executable samples that require libraries (e.g., DLLs) that are not found in the base operating system of the emulation environment and use dynamic analysis to detect malicious code associated with the sample.

In an example implementation, a feature is added to dynamic analysis (DA) engine 310 of FIG. 3 (e.g., implemented using a Hypervisor DA (HvDA)) that can identify libraries that are not part of the base operating system. Based on such findings (e.g., determination if a sample has unmet dependencies prior to attempting to perform execution of the sample), the dynamic analysis engine can identify libraries that are required by the sample to properly execute in the emulation environment. Specifically, the dynamic analysis engine can scan the import table of the sample and extract the library name and all of its imported functions to automatically generate a DLL stub that is to be installed inside the emulation environment together with the executable sample for performing the dynamic analysis for malware detection.

More specifically, the DA engine maintains a list of Windows DLL filenames in the search paths (e.g., extracted from base analysis disk images, including side-by-side assemblies). Libraries can be pre-parsed to obtain exported function names and ordinals. Unmet dependencies can then be replaced with a generated stub library. The sample's import table (e.g., IAT 606 as shown in FIG. 7) can be parsed to find all required functions. A new library can then be automatically generated with the required function identifiers (e.g., names or ordinals). The automatically generated libraries can then be installed in the same folder as the analysis target.

When the emulation environment executes the sample, it will resolve the missing dependencies from the generated DLL. When the sample has been executed, dynamic analysis behaviors and memory snapshots can be used to detect any malicious activity during the dynamic analysis in the instrumented emulation environment (e.g., the instrumented emulation environment will terminate the analysis once an export from the custom DLL gets called or after a predetermined period of time as similarly described above).

The disclosed techniques for dependency emulation of executable samples facilitate many new opportunities for accurate malware detection using dynamic analysis. For example, with memory signatures, unpacking often happens before any API calls are made to such generated stub libraries. Moreover, machine learning can also be applied to memory footprints during such dynamic analysis that previously would not have been available as such executable samples would not have been able to execute due to the missing dependencies. Further, API/behavioral activity before the use of generated library functions can also be used to facilitate malware detection during such dynamic analysis of executable samples with missing dependencies.

In another embodiment, the dynamic analysis can similarly determine that one or more libraries are missing from the sample for execution of the sample in an emulation environment. However, in this example, instead of generating a stub library for any missing dependencies, the dynamic analysis engine is configured to intercept a loader response for a dynamic linked library (DLL) search and generate a spoofed import response to facilitate the execution of the sample in the emulation environment.

In yet another embodiment, the dynamic analysis can similarly determine that one or more libraries are missing from the sample for execution of the sample in an emulation environment. However, in this example, instead of generating a stub library for any missing dependencies, the dynamic analysis engine is configured to index and prefetch any such missing libraries for the emulation environment to facilitate the execution of the sample in the emulation environment (e.g., as such, the prefetched DLL(s) will be present in the OS of the emulation environment to allow the sample to execute and call any such prefetched DLL(s)).

### Example Use Cases for Dependency Emulation for Executable Samples

Approximately 30,000 samples are received per day that require additional libraries to properly execute in the instrumented emulation environment for dynamic analysis at the cloud-based security solution (e.g., using the WildFire™ service that is commercially available from Palo Alto Networks, headquartered in Santa Clara, CA). This has been an issue for many years and identified in numerous False Negative (FN) Root Cause Analysis (RCA) efforts by WildFire analysts.

Examples of samples that can now be detected using the disclosed techniques for dependency emulation for executable samples are provided below as SHA256 hashes of such example samples:
c64269a64b64b20108df89c4fla415936c9d9923f8761d0667aa8492aa057acb
e5d0bc25e288bd9e6d19704b433ff8a1611389b44775fda723d0bbed70806c96
005a45ce5491bf2365ddbc5d9f65d736e23fc8a1939edf513e97a6840ffaf06e

These three SHA256 hashes belong to file infector families named Ramnit, Floxif, and Ryuk, respectively.

### Example Statistics for Dependency Emulation for Executable Samples

One example statistic is that hundreds of samples have been detected that require using the disclosed techniques for dependency emulation for executable samples. Example statistics are provided below.
Number of detected samples: 79649
Number of detected samples that were executing with dependency emulation: 500
Number of detected samples that reached out to stub call: 75

Commonly used external libraries are listed below:
webengine4.dll
qtcore4.dll
bootstraplibrary.dll
jli.dll
qtgui4.dll
groovenew.dll
grooveutil.dll
gvc.dll
d3dx9_43.dll

As will now be apparent to one of ordinary skill in the art, while the above-described embodiments refer to Microsoft Windows PE executable files with dependencies, the disclosed techniques for dependency emulation for executable samples can similarly be applied to various other types of executable files, such as for other OS platforms (e.g., Android OS, iOS, MacOS, Linux, and/or other OS platforms).

Additional example processes for the disclosed techniques for dependency emulation for executable samples will now be described.

### Example Processes for Dependency Emulation for Executable Samples

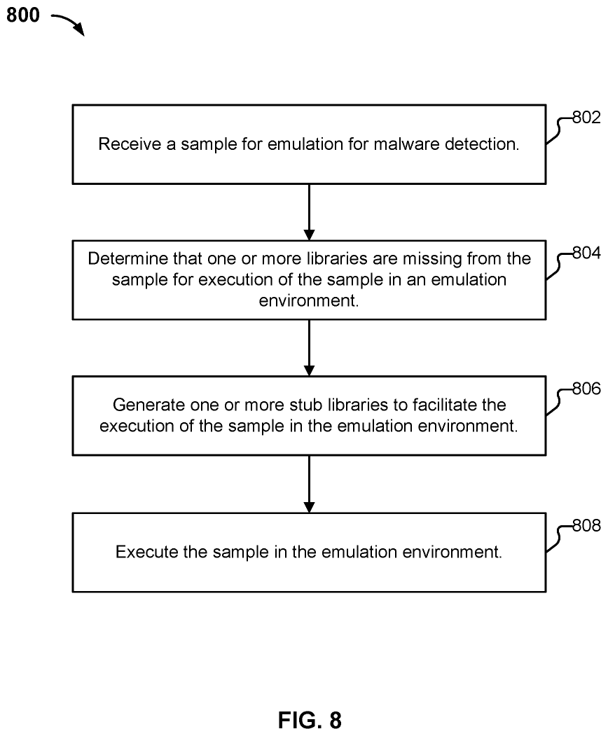

FIG. 8 is a flow diagram of a process for dependency emulation for executable samples in accordance with some embodiments. In some embodiments, a process 800 as shown in FIG. 8 is performed by the security platform and techniques as similarly described above including the embodiments described above with respect to FIGS. 1-7. In one embodiment, process 800 is performed by data appliance 102 as described above with respect to FIG. 1, a virtual appliance (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 802, a sample for emulation for malware detection is received. For example, the sample can be received by a security service for performing a cloud-based security analysis including dynamic analysis of executable samples.

At 804, determining that one or more libraries are missing from the sample for execution of the sample in an emulation environment is performed. For example, the dynamic analysis engine can be configured to determine any missing dependencies associated with the sample prior to attempting to execute the sample in the instrumented emulation environment as similarly described above with respect to FIG. 7.

At 806, generating one or more stub libraries to facilitate the execution of the sample in the emulation environment is performed. For example, the one or more stub libraries can be automatically generated using the dynamic analysis engine to facilitate the execution of the sample in the instrumented emulation environment as similarly described above with respect to FIG. 7.

At 808, the sample is executed in the emulation environment. For example, if the sample is determined to be malicious, then the security policy enforcement can include performing an action in response to detecting that the sample is malware, such as blocking the session, quarantining the session, generating a signature for the sample, generating an alert, logging the sample as malware, and/or another response can be performed.

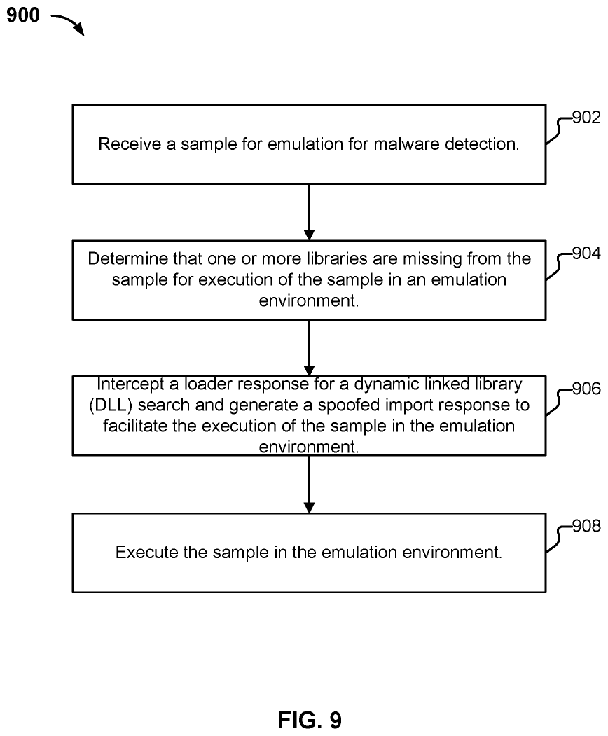

FIG. 9 is another flow diagram of a process for dependency emulation for executable samples in accordance with some embodiments. In some embodiments, a process 900 as shown in FIG. 9 is performed by the security platform and techniques as similarly described above including the embodiments described above with respect to FIGS. 1-7. In one embodiment, process 900 is performed by data appliance 102 as described above with respect to FIG. 1, a virtual appliance (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 902, a sample for emulation for malware detection is received. For example, the sample can be received by a security service for performing a cloud-based security analysis including dynamic analysis of executable samples.

At 904, determining that one or more libraries are missing from the sample for execution of the sample in an emulation environment is performed. For example, the dynamic analysis engine can be configured to determine any missing dependencies associated with the sample prior to attempting to execute the sample in the instrumented emulation environment as similarly described above with respect to FIG. 7.

At 906, intercepting a loader response for a dynamic linked library (DLL) search and generating a spoofed import response to facilitate the execution of the sample in the emulation environment are performed. For example, the loader response for the dynamic linked library (DLL) search can be intercepted and the spoofed import response can be generated using the dynamic analysis engine to facilitate the execution of the sample in the instrumented emulation environment as similarly described above with respect to FIG. 7.

At 908, the sample is executed in the emulation environment. For example, if the sample is determined to be malicious, then the security policy enforcement can include performing an action in response to detecting that the sample is malware, such as blocking the session, quarantining the session, generating a signature for the sample, generating an alert, logging the sample as malware, and/or another response can be performed.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive a sample for emulation for malware detection;
determine that one or more libraries are missing from the sample for execution of the sample in an emulation environment;
generate one or more stub libraries to facilitate the execution of the sample in the emulation environment; and
execute the sample in the emulation environment; and
a memory coupled to the processor and configured to provide the processor with instructions.

2. The system recited in claim 1, wherein the emulation environment comprises a virtual machine instance.

3. The system recited in claim 1, wherein the emulation environment comprises a virtual is machine instance for a Windows operating system environment.

4. The system recited in claim 1, wherein the emulation environment comprises a virtual machine instance for a Linux operating system environment.

5. The system recited in claim 1, wherein the emulation environment comprises a virtual machine instance for an Apple OSX or iOS operating system environment.

6. The system recited in claim 1, wherein the emulation environment comprises a virtual machine instance for an Android operating system environment.

7. The system recited in claim 1, wherein the sample comprises an executable file.

8. The system recited in claim 1, wherein the sample comprises an executable file that is missing at least one or more libraries that are a dependency for execution.

9. The system recited in claim 1, wherein the sample comprises a Windows PE file.

10. The system recited in claim 1, wherein the sample comprises a Windows PE file that is missing at least one or more libraries that are a dependency for execution.

11. The system recited in claim 1, wherein the processor is further configured to:
receive a plurality of malware samples; and
deduplicate the plurality of malware samples.

12. The system recited in claim 1, wherein the processor is further configured to:
receive a plurality of malware samples;
deduplicate the plurality of malware samples to output a first malware sample; and
execute the first malware sample in the emulation environment.

13. The system recited in claim 1, wherein the processor is further configured to:
terminate an entire process.

14. The system recited in claim 1, wherein the processor is further configured to:
terminate a thread associated with a stub library call.

15. A method, comprising:
receiving a sample for emulation for malware detection;
determining that one or more libraries are missing from the sample for execution of the is sample in an emulation environment;
generating one or more stub libraries to facilitate the execution of the sample in the emulation environment; and
executing the sample in the emulation environment.

16. The method of claim 15, wherein the emulation environment comprises a virtual machine instance.

17. A computer program product, the computer program product being embodied in a tangible computer readable storage medium and comprising computer instructions for:
receiving a sample for emulation for malware detection;
determining that one or more libraries are missing from the sample for execution of the sample in an emulation environment;
generating one or more stub libraries to facilitate the execution of the sample in the emulation environment; and
executing the sample in the emulation environment.

18. The computer program product recited in claim 17, wherein the emulation environment comprises a virtual machine instance.

19. A system, comprising:
a processor configured to:
receive a sample for emulation for malware detection;
determine that one or more libraries are missing from the sample for execution of the sample in an emulation environment;
intercept a loader response for a dynamic linked library (DLL) search and generate a spoofed import response to facilitate the execution of the sample in the emulation environment; and
execute the sample in the emulation environment; and
a memory coupled to the processor and configured to provide the processor with instructions.

20. The system recited in claim 19, wherein the emulation environment comprises a virtual is machine instance.
